(19) United States
(12) Patent Application Publication
(10) Pub. No.: US 2006/0219100 A1
(43) Pub. Date: Oct. 5, 2006

(54) Self stirring, heating and cooking assembly having interchangeable stirring devices

(76) Inventor: Jonathan D. Gelfand, Los Angeles, CA (US)

Correspondence Address: SNELL & WILMER LLP, 600 ANTON BOULEVARD, SUITE 1400, COSTA MESA, CA, 92626, US

(21) Appl. No.: 11/099,271

(22) Filed: Apr. 5, 2005

(51) Int. Cl. A21B 7/00

(52) U.S. Cl. 99/348

(57) ABSTRACT

A self stirring cooking assembly including a container defined by a bottom surface and a side surface extending up from the bottom surface, a stirring device having an arm positioned to rotate along the bottom surface of the container, the arm having a non-rectangular cross-section, and a motor configured to rotate the stirring device. The self stirring cooking assembly may have a base having a motor control for controlling the motor, where the motor is positioned in the base. The self stirring cooking assembly may also have a heating element coupled to the base or positioned within the container. That is, the heating element may be positioned on the base or within the stirring device.

### FIELD OF THE INVENTION

The invention relates generally to a self stirring, heating and cooking assembly, and more particularly to a self stirring, heating and cooking assembly having interchangeable stirring devices.

### DESCRIPTION OF RELATED ART

Containers (e.g., pots and pans) may be used to heat and/or cook food on conventional electric or gas stoves. After placing the container on the stove, a user generally turns on the stove, places the food in the container and stands by the stove to repeatedly stir the food. The user must repeatedly stir the food in the container, otherwise, the food may be burned or overcooked. Requiring the food to be repeatedly stirred is burdensome and inconvenient. Moreover, if the food needs to be slow-cooked, the user may have to wait by the food for several hours.

To overcome the above drawbacks, several automatic stirring devices have been developed to stir food in a container. For example, U.S. Pat. No. 5,013,158 issued to Tarlow discloses a self stirring assembly disposed within a container having a cover. The self stirring assembly is mounted to the cover of the container and has arms that travel along the bottom of the container. U.S. Pat. No. 5,617,774 issued to LaVelle discloses a container having a handle connected to a self stirring cooking device. The self stirring cooking device includes a vertical shaft with a blade attached normally thereto. The blade rotates along the bottom surface of the container.

Additionally, U.S. Pat. No. 6,026,735 issued to Waterworth discloses a self stirring cooking assembly having a cooking receptacle. A stirring arm is located within the cooking receptacle and has a horizontal blade member that is disposed immediately adjacent to the bottom surface of the cooking receptacle. Vertically depending from each end of the horizontal blade member is an elongated, substantially wedge-shaped paddle that extends upwardly along the side walls of the cooking receptacle.

The automatic stirring devices described above provide for the basic function and purpose of stirring foods, however, they have several drawbacks. For example, the automatic stirring devices are not capable of switching directions when blocked or stopped by the food or periodically for better stirring of the food. Also, the automatic stirring devices do not have interchangeable stirring members for the stirring of different types of foods and the stirring members do not scrape the bottom and side surfaces of the pot. Furthermore, the stirring devices are not specifically designed for heating and stirring certain types of foods.

### SUMMARY OF THE INVENTION

In particular, and by way of example only, one embodiment of the invention includes a self stirring cooking assembly including a container defined by a bottom surface and a side surface extending up from the bottom surface, a heating element for providing heat to the container, a stirring device having an arm positioned to rotate along the bottom surface of the container, the arm having a non-rectangular cross-section, and a motor configured to rotate the stirring device. The self stirring cooking assembly may have a base having a motor control for controlling the motor, where the motor is positioned in the base. The self stirring cooking assembly may also have a heating element coupled to the base or positioned within the container. For example, the heating element may be positioned inside or within the stirring device.

One embodiment of the invention includes a self stirring cooking assembly including a base, a container having a bottom surface and configured to be positioned on the base, a bowl positioned adjacent to the bottom surface, and a paddle positioned to rotate within the bowl. The self stirring cooking assembly may have a heating element coupled to the base or positioned within the container. For example, the heating element may be positioned along a top portion of the base.

One embodiment of the invention includes a self stirring cooking assembly including a container defined by a bottom surface and a side surface extending up from the bottom surface, a stirring device having a bar positioned to rotate along the bottom surface of the container, and a motor configured to rotate the stirring device. The stirring device may have a spacing member connected to the bar. The bar may have a first diameter and the spacing member may have a second diameter that is greater than the first diameter. The self stirring cooking assembly may have a heating element coupled to the base or positioned within the container. For example, the heating element may be positioned along a top portion of the base.

These and other features and advantages of the embodiments of the invention will become apparent from the following detailed description, taken in conjunction with the accompanying drawings, which illustrate, by way of example, the principles of the invention.

### BRIEF DESCRIPTION OF THE DRAWINGS

FIG. 1 is a perspective view of a self stirring cooking assembly having a base and a container positioned on the base according to an embodiment of the invention;

FIG. 2 is a perspective view of the base of FIG. 1 where the container has been removed to show components of the base such as a heating element, a connector, a ring and an opening according to an embodiment of the invention;

FIG. 3 is a perspective view of a container where its cover has been removed to show the inside of the container according to an embodiment of the invention;

FIG. 4A is a perspective view of a stirring device that is removably attachable to the center support and the pin according to an embodiment of the invention;

FIGS. 4B-4E are cross-sectional views of different shapes of various stirring devices according to various embodiments of the invention;

FIG. 5 is a front view of the stirring device of FIG. 4 to illustrate the protrusions having a staggered configuration according to an embodiment of the invention;

FIG. 6 is a perspective view of a stirring device that is removably attachable to the center support and the pin according to an embodiment of the invention;

FIG. 7 is a front view of the stirring device of FIG. 6 to illustrate the left and right inner paddles according to an embodiment of the invention;

FIG. 8 is a front view of a stirring device that can be used to cook or make popcorn according to an embodiment of the invention;

FIG. 9 is a perspective view of a self stirring cooking assembly having the base, the container positioned on the base, a bowl that fits in the container and a paddle that fits within the bowl according to an embodiment of the invention; and

FIG. 10 is a front view of the self stirring cooking assembly of FIG. 9 according to an embodiment of the present invention.

### DETAILED DESCRIPTION OF THE PREFERRED EMBODIMENTS

Devices and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

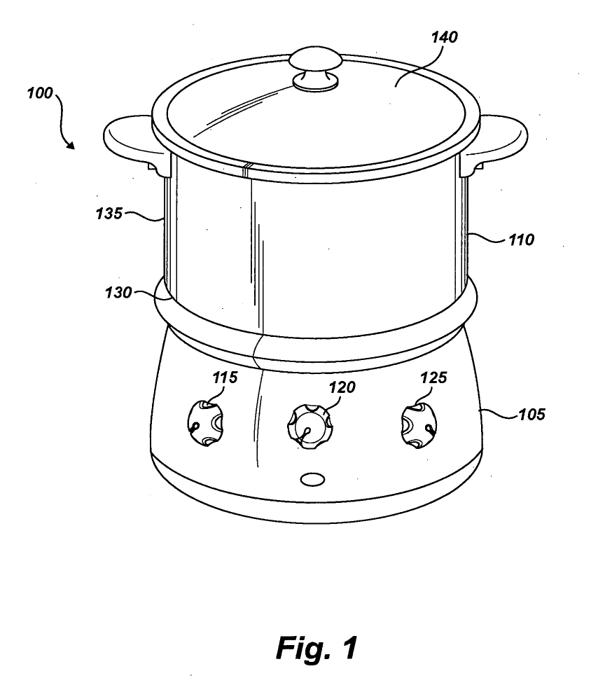

Referring now more particularly to the drawings, FIG. 1 is a perspective view of a self stirring cooking assembly 100 having a base 105 and a container 110 (e.g., a pot or a pan) positioned on the base 105. The base 105 has a timer control 115, a temperature control 120, and a speed/direction control 125. The container 110 has a bottom surface 130 and a cylindrical side surface 135 extending up from the bottom surface 130. The base 105 and the container 110 may be made of a metallic material such as aluminum or stainless steel. The container 110 can be configured in a variety of shapes and sizes depending on the amount and type of food being cooked. A cover 140 may placed over the container 110 to contain the heat and stream within the container 110. The cover 140 can be made of a see through material such as glass or plastic and can be used with a number of different containers 110.

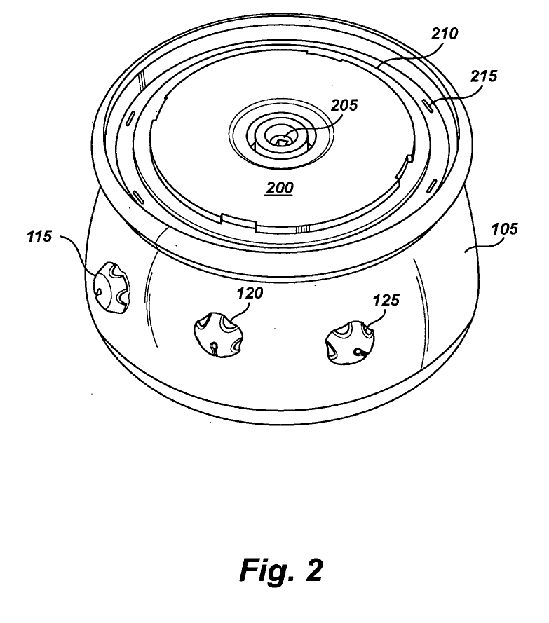

FIG. 2 is a perspective view of the base 105 of FIG. 1 where the container 110 has been removed to show components of the base 105 such as a heating element 200, a connector 205, a ring 210 and openings 215. The heating element 200 is controlled by the temperature control 120, which has variable heat settings ranging from low (e.g., 150 degrees F.) to high (e.g., 410 degrees F.). In the illustrated embodiment, the heating element 200 is formed in the shape of a plate and is made of an aluminum material. The connector 205 is used to attach a motor (not shown) in the base 105 to a stirring device that rotates in the container 110. In one embodiment, the connector 205 can provide heat to the stirring device. For example, a heating element can be located in or adjacent to the stirring device to heat the food in the container 110.

The base 105 includes a safety mechanism that may be independent of or part of the connector 205 for prohibiting the heating element 200 from generating heat or allowing the motor in the base 105 to rotate a stirring device when the container 110 is not attached to the base 105. Hence, when the container 110 is removed from the base 105, the safety mechanism may prevent the user from getting burned by the heating element 200 or injured from a stirring device. In one embodiment, the base 105 can include one or magnets that are used to rotate the stirring device. For example, the stirring device can include magnets in the arms that repel the magnets located in the base 105. The magnets in the base 105 can be stationary or can rotate causing the stirring device or paddle to rotate within the container 110. The magnets can be in addition to or in lieu of the motor.

The connector 205 is attached to the motor, which is positioned below the heating element 200 in the base 105. In one embodiment, the motor is positioned centrally below the heating element 200. The motor is used to rotate the connector 205, which in turn rotates the stirring device. In one embodiment, the motor rotates the stirring device at approximately 3 to 6 revolutions per minute (rpm) in a clockwise or counterclockwise direction. The motor can provide several hours of continuous operation. The speed/direction control 125 can set the motor to rotate the stirring device in a number of different ways. Table I below illustrates some exemplary speed and direction control settings for the motor.

TABLE I
Exemplary Speed and Direction Control Settings for the Motor

| Speed Control | |
|---|---|
| Settings | Motor Operations |
| Rotate | Constantly rotates the stirring device in a |
| | clockwise direction |
| Rotate/Stop | Rotates the stirring device in a clockwise |
| | direction for 30 seconds; Stops the stirring |
| | device for 30 seconds (Repeats) |
| Rotate/Reverse | Rotates the stirring device in a clockwise |
| | direction for 30 seconds; Rotates the |
| | stirring device in a counter-clockwise |
| | direction for 30 seconds (Repeats) |
| Rotate/Stop/Reverse | Rotates the stirring device in a clockwise |
| | direction for 30 seconds; Stops the stirring |
| | device for 30 seconds; Rotates the stirring |
| | device in a counter-clockwise direction for |
| | 30 seconds (Repeats) |
| Reverse | Constantly rotates the stirring device in a |
| | counter-clockwise direction |

In one embodiment, the base 105 does not include the motor and the connector 205 but instead the motor is located within the hub of the stirring device.

The ring 210 is used to hold the heating element 200 in place and the openings 215 are used to secure the container 110 to the base 105. That is, in one embodiment, the container 110 has bottom clips for slidable attachment to the openings 215.

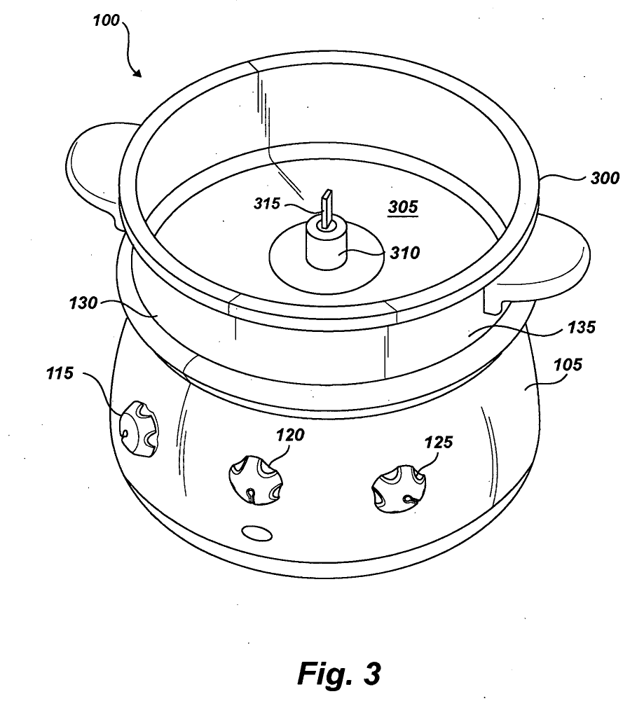

FIG. 3 is a perspective view of a container 300 where its cover 140 has been removed to show the inside of the container 300. The container 300 has a bottom surface 305, a center support 310 protruding from the bottom surface 305, and a pin 315 protruding through the center support 310. The center support 310 is fixed to the bottom surface 305 of the container 300. The pin 315 is positioned and designed to connect to the connector 205 when the container 300 is attached to the base 105 and a stirring device. As the motor rotates the connector 205, the pin 315 rotates at the same speed as the connector 205. The center support 310 does not rotate with the pin 315 but rather acts as a support for the rotation of the pin 315. Additionally, the center support 310 protrudes above the bottom surface 305 to provide support for the stirring devices and to prevent food that is in the container 300 from entering the interface between the center support 310 and the pin 315.

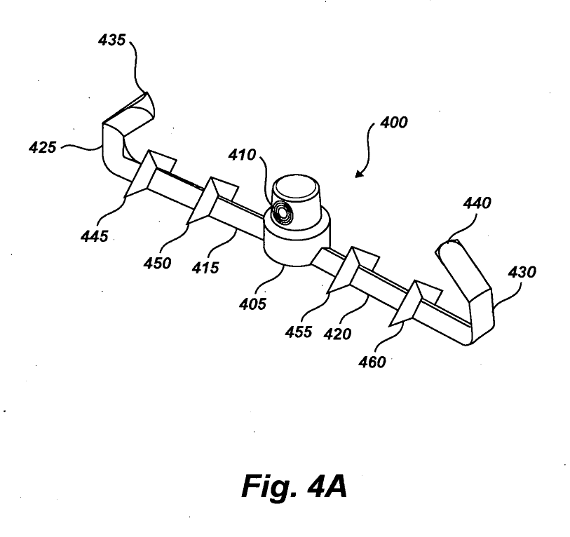

FIG. 4A is a perspective view of a stirring device 400 that is removably attachable to the center support 310 and the pin 315. The stirring device 400 may include a hub 405 having a grippable portion 410, left and right arms 415 and 420, left and right upright members 425 and 430, and left and right angled members 435 and 440. In one embodiment, the stirring device 400 includes the left arm 415, the left upright member 425 and the left angled member 435. The hub 405 fits over the center support 310 and the pin 315 and has an internal connector that attaches to the pin 315. In one embodiment, the motor can be positioned within the hub 405. Depending on the configuration of the motor and the hub 405, the center support 310 and the pin 315 may be optional. For example, the pin 315 may be removed when the motor is positioned within the hub 405 because the pin 315 may not needed to be attached to the connector 205.

The stirring device 400 can be attached to the pin 315 by placing the hub 405 over the center support 310 and pushing the hub 405 down to the bottom surface 305. The stirring device 400 can be detached from the pin 315 by pressing on the grippable portion 410 and lifting the hub 405 away from the bottom surface 305. In one embodiment, the stirring device 400 is made of a hard plastic; silicon or rubber material that does not scratch the bottom surface 130 or the cylindrical side surface 135 of the container 300. In one embodiment, the stirring device 400 has an internal metal frame coated with a hard plastic, silicon or rubber material.

The left and right arms 415 and 420 extend in a horizontal direction from the hub 405 toward the cylindrical side surface 135 of the container 110. The left and right arms 415 and 420 are positioned adjacent to the bottom surface 130 and rotate in a clockwise or counterclockwise direction. In one embodiment, the left and right arms 415 and 420 scrape the bottom surface 305 of the container 300. The left and right arms 415 and 420 may have a non-rectangular cross-section. For example, the cross-section can have a triangular shape (FIG. 4B), a sloped triangular shape (FIG. 4C), a bell shape (FIG. 4D), a curved ramp shape (FIG. 4E) or other sloping or curved shapes to allow the food to be lifted up and over the left and right arms 415 and 420. In one embodiment, the left and right arms 415 and 420 have a base that is about 1 cm and a height that is about 1 cm. These various shapes allows for better mixing and stirring of the food positioned on the bottom surface 305 of the container 300. In various embodiments, the stirring device 400 can have only one arm (e.g., the left arm 415) or two or more arms. For example, the stirring device 400 can have three or four arms that are spaced the same distance apart from one another. The additional arms may further enhance the mixing and stirring of the food within the container 300.

The left and right upright members 425 and 430 extend upward from the ends of the left and right arms 415 and 420, respectively. In various embodiments, the left and right upright members 425 and 430 can have the various shapes described above to allow the food positioned on the cylindrical side surface 135 to be lifted up and over the left and right upright members 425 and 430. The left and right upright members 425 and 430 are positioned adjacent to the cylindrical side surface 135. In one embodiment, the left and right upright members 425 and 430 scrape the cylindrical side surface 135 of the container 110. In various embodiments, the stirring device 400 can have only one upright member (e.g., the left upright member 425) or two or more upright members extending from the arms. For example, the stirring device 400 can have three or four upright members extending from the arms. The additional upright members may further enhance the mixing and stirring of the food within the container 300.

The left and right angled members 435 and 440 can have the various shapes described above and extend inward from the left and right upright members 425 and 430, respectively. The angle of the left and right angled members 435 and 440 can vary depending on the type of food being stirred. The angle is preferably between about 1 and 179 degrees, more preferably between about 25 and 155 degrees, and most preferably about 45 degrees (shown in FIG. 4A). The angle is measured from a vertical axis defined by the left and right upright members 425 and 430. The left and right angled members 435 and 440 extend inward toward the center of the container 300 to allow the food positioned above the left and right arms 415 and 420 to be mixed or stirred. The left and right angled members 435 and 440 can extend to the center of the container 300 such that the ends of the left and right angled members 435 and 440 are positioned adjacent to or over the hub 405. In various embodiments, the stirring device 400 can have only one angled member (e.g., the left angled member 435) or two or more angled members. For example, the stirring device 400 can have three or four angled members that are spaced the same distance apart from one another. The additional angled members may further enhance the mixing and stirring of the food within the container 300.

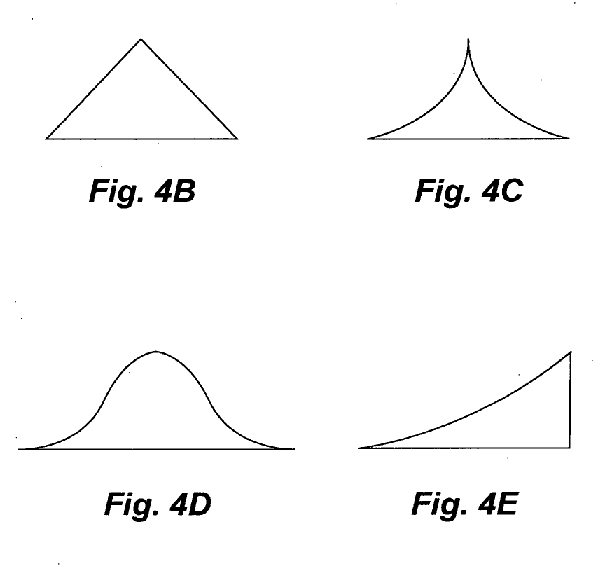

The stirring device 400 may further include first and second protrusions 445 and 450 on the left arm 415 and third and fourth protrusions 455 and 460 on the right arm 420. The protrusions are optional components of the stirring device 400. In one embodiment, each of the protrusions has a triangular shape. In one embodiment, the left and right arms 415 and 420 have a first height H1 (e.g., 1 cm) and the protrusions have a second height H2 (e.g., 2 cm), which is greater than the first height H1 (see FIG. 5). In one embodiment, each protrusion can have a different height for better mixing and stirring of the food. The stirring device 400 may include any number (e.g., 1, 2, 3, etc.) of protrusions designed and configured for better mixing and stirring of the food.

FIG. 5 is a front view of the stirring device 400 of FIG. 4 to illustrate the protrusions having a staggered configuration. In one embodiment, the protrusions are staggered (i.e., none of the protrusions are located the same distance away from the hub 405) along the left and right arms 415 and 420. For example, the first protrusion 445 may be positioned A cm from the hub 405, the second protrusion 450 may be positioned B cm from the hub 405, the third protrusion 455 may be positioned C cm from the hub 405, and the fourth protrusion 460 may be positioned D cm from the hub 405, where A, B, C and D are different distances or lengths. The staggering of the protrusions allows for better mixing, stirring and movement of the food.

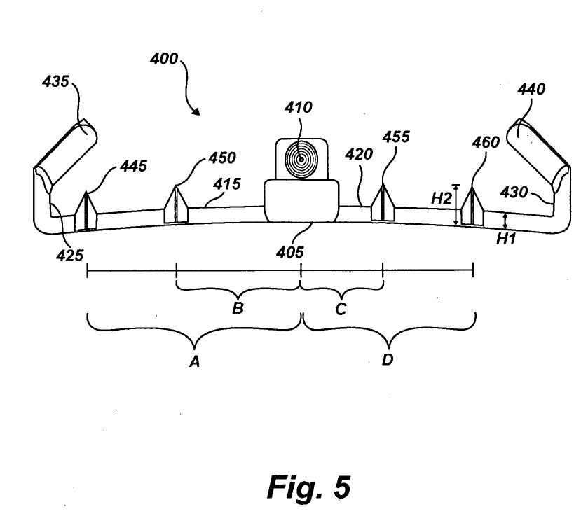

FIG. 6 is a perspective view of a stirring device 600 that is removably attachable to the center support 310 and the pin 315. The stirring device 600 includes the hub 405 having the grippable portion 410, the left and right arms 415 and 420, the left and right upright members 425 and 430, the left and right angled members 435 and 440, and left and right inner paddles 605 and 610. The left and right inner paddles 605 and 610 are connected to the hub 405 and may be tilted relative to a vertical plane passing through the left and right arms 415 and 420. In one embodiment, the left and right upright members 425 and 430 rotate in the same direction as the left and right inner paddles 605 and 610. In one embodiment, the left and right upright members 425 and 430 rotate in the opposite direction as the left and right inner paddles 605 and 610. For example, the left and right upright members 425 and 430 rotate in a clockwise direction and the left and right inner paddles 605 and 610 rotate in a counter-clockwise direction. In order to rotate in opposite directions, the hub 405 may include a gear assembly. The left and right inner paddles 605 and 610 may have flat front and rear surfaces to stir the food. The stirring device 600 may be used to stir foods such as beans, meats, pastas, sauces, soups, and vegetables.

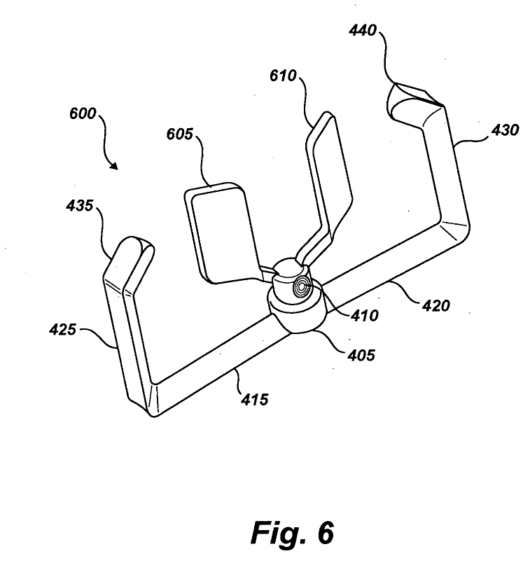

FIG. 7 is a front view of the stirring device 600 of FIG. 6 to illustrate the left and right inner paddles 605 and 610. In one embodiment, the left and right inner paddles 605 and 610 have a height H of about 7.0 cm and a width W of about 3.5 cm. The left and right inner paddles 605 and 610 are sized and configured depending on the type of food being stirred and the size and dimensions of the container 110. The height H is generally less than the height of the container 300.

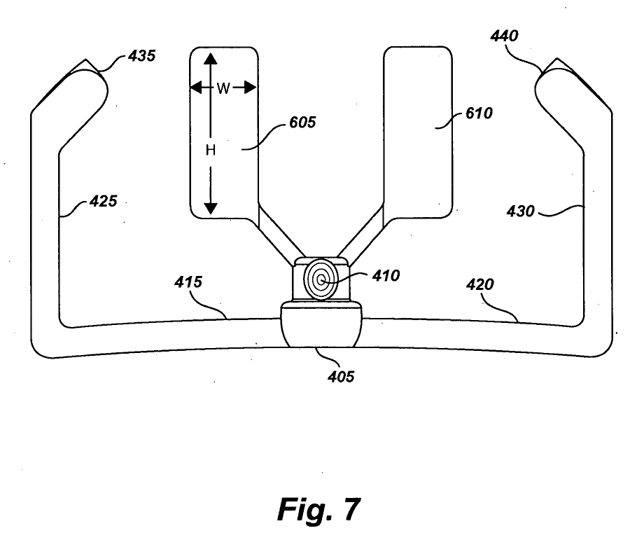

FIG. 8 is a front view of a stirring device 800 that can be used to cook or make popcorn, roast nuts, or coffee beans or otherwise mix foods. The stirring device 800 may include a bar 805 connected to the hub 405 and spacing members 810 (optional) connected to the bar 805 or the ends of the bar 805. The bar 805 may be a cable, wire, shaft, stick or rod and the spacing members 810 may be balls, squares or spacers. In one embodiment, the bar 805 has a diameter of about 3 millimeters (mm) and the spacing members 810 have a diameter of about 6 mm. The bar 805 and the spacing members 810 can be made of a metallic material (e.g., aluminum or steel) coated with a plastic, silicon or rubber material. The spacing members 810 allow the bar 805 to be positioned slightly above and not in contact with the bottom surface 305 of the container 300. When making popcorn, for example, the bar 805 travels above any oil placed on the bottom surface 305 but moves and rotates the popcorn kernels. Therefore, the popcorn kernels are allowed to cook in and be rotated throughout the oil resting on the bottom surface 305. The spacing members 810 are used to space the bar 805 apart from the bottom surface 305. Therefore, the spacing members 810 have a diameter that is greater than the diameter of the bar 805.

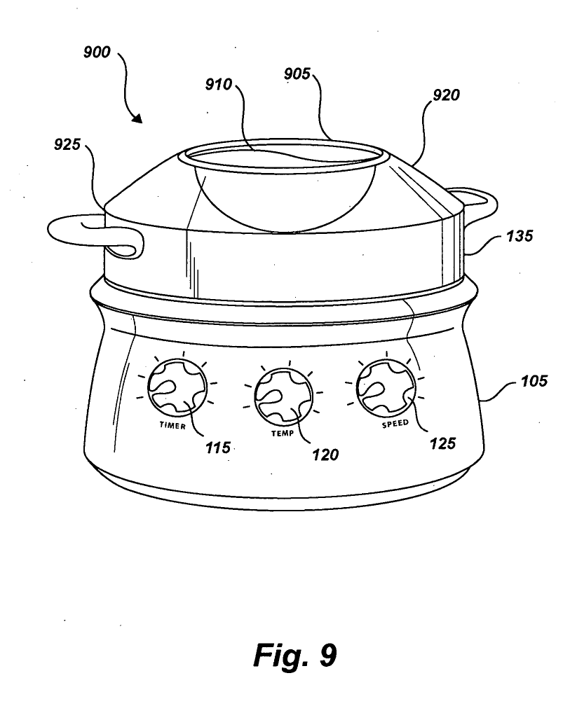

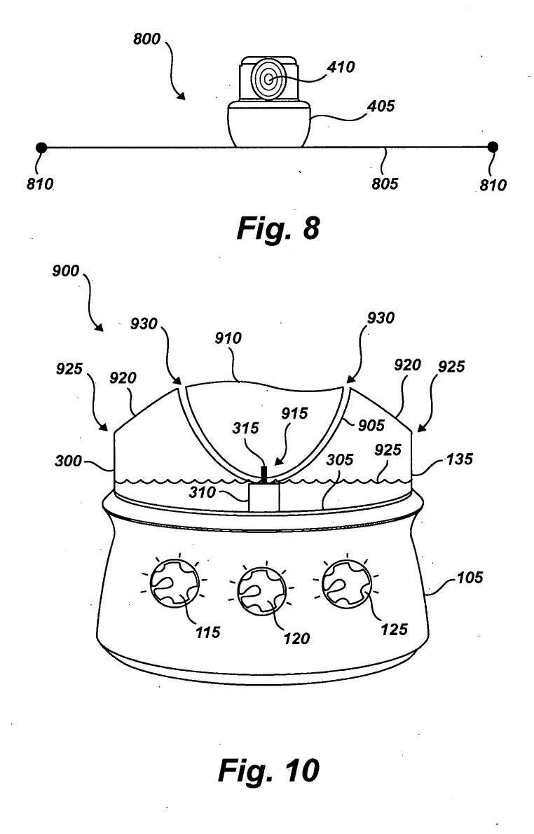

FIGS. 9 and 10 are perspective and front views of a self stirring cooking assembly 900 having the base 105, the container 300 positioned on the base 105, a bowl 905 that fits in the container 300, and a paddle 910 that fits within the bowl 905. The bowl 905 has an opening 915 at its base to allow the pin 315 to pass therethrough and connect to the paddle 910. A cover 920 may be used to surround the bowl 905, enclose the container 300 and contain any steam or heat formed within the container 300. The cover 920 may be placed above the bottom surface 305 of the container 300 and circumferentially attach or connect to a lip 925 of the container 300. The cover 920 may be made of a clear, see through plastic or glass material.

The bowl 905 can be used to heat up liquid or food without direct contact with the bottom surface 305. For example, some foods such as chocolate are better prepared when indirect heat is used. One way to provide indirect heat is to provide water 925 in the container 300 and heat the water 925 to provide heat and steam to the bowl 905. When the bowl 905 is heated, its contents are also heated.

The paddle 910, which is positioned in the bowl 905, may be configured in the shape of the bowl 905. For example, the bowl 905 and the paddle 910 may be configured in the shape of a semicircle. The bowl 905 and the paddle 910 may be configured so that a gap 930 is present between the bowl 905 and the paddle 910 to allow for fluid or food to pass therethrough. In one embodiment, the gap 920 is about 1 cm.

Although an exemplary embodiment of the invention has been shown and described, many other changes, combinations, omissions, modifications and substitutions, in addition to those set forth in the above paragraphs, may be made by one having skill in the art without necessarily departing from the spirit and scope of this invention. Accordingly, the invention is not intended to be limited by the preferred embodiments, but is to be defined by reference to the appended claims.

What is claimed is:

1. A self stirring cooking assembly comprising:
a container defined by a bottom surface and a side surface extending up from the bottom surface;
a heating element for providing heat to the container;
a stirring device having an arm positioned to rotate along the bottom surface of the container, the arm having a non-rectangular cross-section; and
an apparatus configured to rotate the stirring device.

2. The self stirring cooking assembly of claim 1 further comprising a base having a control for controlling the apparatus, wherein the apparatus is positioned in the base.

3. The self stirring cooking assembly of claim 1 wherein the stirring device includes an upright member connected to the arm.

4. The self stirring cooking assembly of claim 3 wherein the upright member has a sloping shape.

5. The self stirring cooking assembly of claim 3 wherein the stirring device includes an angled member connected to the upright member.

6. The self stirring cooking assembly of claim 5 wherein the upright member defines a first axis and the angled member defines a second axis that is positioned at an angle of between about 25 and 155 degrees from the first axis.

7. The self stirring cooking assembly of claim 1 wherein the stirring device includes a hub and the arm extending from the hub and including first and second protrusions.

8. The self stirring cooking assembly of claim 7 wherein the first protrusion is positioned a first distance away from the hub and the second protrusion is positioned a second distance away from the hub, the first distance being different from the second distance.

9. The self stirring cooking assembly of claim 1 wherein the stirring device includes left and right inner paddles.

10. The self stirring cooking assembly of claim 1 wherein the stirring device includes a heating element.

11. The self stirring cooking assembly of claim 1 wherein the apparatus is configured to rotate the stirring device in clockwise and counter-clockwise directions.

12. The self stirring cooking assembly of claim 1 wherein the apparatus is configured to rotate the stirring device for a first period of time and stop the stirring device from rotating for a second period of time.

13. The self stirring cooking assembly of claim 1 wherein the apparatus is configured to rotate the stirring device in a clockwise direction for a first period of time, stop the stirring device from rotating for a second period of time and rotate the stirring device in a counter-clockwise direction for a third period of time.

14. The self stirring cooking assembly of claim 1 wherein the apparatus is selected from a group consisting of a motor and a magnet.

15. A self stirring cooking assembly comprising:
a base;
a container having a bottom surface and configured to be positioned on the base, the container configured to hold a fluid;
a bowl positioned adjacent to the bottom surface; and
a paddle positioned to rotate within the bowl.

16. The self stirring cooking assembly of claim 15 further comprising:
a heating element for providing heat to the fluid to produce steam, which heats the bowl; and
a cover configured to be positioned over the bottom surface of the container to hold the steam within the container.

17. The self stirring cooking assembly of claim 16 wherein the heating element is coupled to the base.

18. The self stirring cooking assembly of claim 15 further comprising a motor configured to rotate the paddle in clockwise and counter-clockwise directions.

19. The self stirring cooking assembly of claim 18 wherein the motor is configured to rotate the paddle for a first period of time and stop the paddle from rotating for a second period of time.

20. The self stirring cooking assembly of claim 18 wherein the motor is configured to rotate the paddle in a clockwise direction for a first period of time, stop the paddle from rotating for a second period of time and rotate the paddle in a counter-clockwise direction for a third period of time.

21. The self stirring cooking assembly of claim 15 further comprising one or more magnets located in the base and configured to rotate the paddle.

22. A self stirring cooking assembly comprising:
a container defined by a bottom surface and a side surface extending up from the bottom surface;
a stirring device having a bar positioned to rotate along the bottom surface of the container; and
a motor configured to rotate the stirring device.

23. The self stirring cooking assembly of claim 22 wherein the stirring device has a spacing member positioned on the bar for preventing the bar from coming into contact with the bottom surface of the container.

24. The self stirring cooking assembly of claim 22 wherein the bar has a first diameter and the spacing member has a second diameter that is greater than the first diameter.

25. The self stirring cooking assembly of claim 22 further comprising:
a base having a motor control for controlling the motor, wherein the motor is positioned in the base; and
a heating element coupled to the base.
